(19) United States
(12) Patent Application Publication
(10) Pub. No.: US 2018/0073903 A1
(43) Pub. Date: Mar. 15, 2018

(54) Oil-gas-water three-phase flow meter

(71) Applicant: Xinjiang Zhongyuan Tianneng Oil & Gas Technology Co., LTD., Urumqi, Xinjiang (CN)

(72) Inventors: Jiuqing Lu, Urumqi, Xinjiang (CN); Lianggui Wang, Urumqi, Xinjiang (CN); Jiajun Lu, Urumqi, Xinjiang (CN); Hongchun Wang, Urumqi, Xinjiang (CN); Yongbin Ding, Urumqi, Xinjiang (CN); Feng Zhu, Urumqi, Xinjiang (CN); Qi Zhou, Urumqi, Xinjiang (CN); Binchen Wang, Urumqi, Xinjiang (CN); Yu He, Urumqi, Xinjiang (CN); Xiaodong Kou, Urumqi, Xinjiang (CN)

(21) Appl. No.: 15/525,586

(22) PCT Filed: Jan. 24, 2017
(86) PCT No.: PCT/CN2017/072454

§ 371 Date: May 10, 2017

(30) Foreign Application Priority Data
Feb. 2, 2016 (CN) 201610089485.5

(51) Int. Cl. G01F 1/74

(52) U.S. Cl. CPC G01F 1/74

(57) ABSTRACT

An oil-gas-water three-phase flow meter comprises a main pipeline, wherein a commingler, a pressure sensor and a gas-liquid two-phase flow meter are respectively provided on a horizontal straight pipe section of the main pipeline, a flow computer is provided on a gauge outfit of the gas-liquid two-phase flow meter, a sampling by-pass pipe is connected on the horizontal straight pipe section of the main pipeline between the commingler and the gas-liquid two-phase flow meter, a flow regulating valve and a gas-liquid cylindrical cyclone are provided on the sampling by-pass pipe, a vapor pipeline on a top of the gas-liquid cylindrical cyclone is connected with a gas flow meter, a bottom of the gas-liquid cylindrical cyclone is connected with the liquid outlet pipeline, a mass flow meter.

### CROSS REFERENCE OF RELATED APPLICATION

This is a U.S. National Stage under 35 U.S.C 371 of the International Application PCT/CN2017/072454, filed Jan. 24, 2017, which claims priority under 35 U.S.C. 119(a-d) to CN201610089485.5, filed Feb. 2, 2016.

### BACKGROUND OF THE PRESENT INVENTION

### Field of Invention

The present invention relates to the technical field of a multi phase measuring technique, and more particularly to an oil-gas-water three-phase flow meter.

### Description of Related Arts

Currently, due to the small size and high cost-effective, the all-in-one gas-liquid two-phase flow meter has strong market competitiveness and has been widely applied, popularized and well received in the gas-liquid two-phase flow meter market. In particular, the all-in-one gas-liquid two-phase flow meter has promising prospects in measuring the flow of liquid containing shale gas, liquid containing shale gas and thin oil well. However, the conventional multiphase measurement products have a small measurement range, e.g., with a turndown at 6:1 or 10:1; an in-operation gas-liquid volume ratio of 10-100:1, which is far short of satisfying the process measuring requirement. In addition, some clients needs an oil-gas-water three phase measurement. If the conventional sampling gas-liquid separation method is adopted, the subsequent measurement of water content in oil requires multiple of electric valve. The separator belongs to a pressure vessel and has a high potential safety hazard, a high administrative cost and a huge volume, and is suitable for the measurement of a high-pressure medium. If other types of on-line measurement are adopted for oil-gas-water phase separation rate, the structure is complex, the cost is high and the stability is poor; and in addition, most of the products are equipped with radioactive sensor, which is unwilling to accept by many users. The present invention solved the two difficult problems mentioned above very well.

### SUMMARY OF THE PRESENT INVENTION

An object of the present invention is to provide an oil-gas-water three-phase flow meter with a wide measurement range and combined by a gas-liquid two-phase flow meter and a small sampling measuring water content in oil device. The oil-gas-liquid three-phase flow meter has an in-operation vapor liquid volume ratio of 1000:1, and a range ratio up to 300:1, wherein the present invention has a characteristics of a small volume and a high cost effective.

Accordingly, in order to accomplish the above objects, the present invention adopts a technical solution as follows.

An oil-gas-water three-phase flow meter comprises: a main pipeline; wherein a commingler, a pressure sensor and a gas-liquid two-phase flow meter are respectively provided on a horizontal straight pipe section of the main pipeline, a flow computer is provided on a gauge outfit of the gas-liquid two-phase flow meter, a sampling by-pass pipe is connected on the horizontal straight pipe section of the main pipeline between the commingler and the gas-liquid two-phase flow meter, a flow regulating valve and a gas-liquid cylindrical cyclone are provided on the sampling by-pass pipe, a vapor pipeline on a top of the gas-liquid cylindrical cyclone is connected with a gas flow meter, a bottom of the gas-liquid cylindrical cyclone is connected with the liquid outlet pipeline, a mass flow meter; or an oil cut meter and a liquid flow meter are provided on a horizontal straight pipe section of the liquid outlet pipeline; the flow computer is respectively connected with the pressure sensor and the mass flow meter; or the oil cut meter and the liquid flow meter via a data line.

A differential pressure switch valve is connected on an output terminal of the gas-liquid two-phase flow meter on the main pipeline, a small diameter and low flow rate flow meter is connected in parallel on two terminals of the differential pressure switch valve, wherein the small diameter and low flow rate flow meter is connected with the flow computer via a data line.

The small diameter and low flow rate flow meter is a throttle flow meter, a velocity flow meter or a ultrasonic flow meter.

A product of a volume and a pressure of the gas-liquid cylindrical cyclone is less than 2.5 MpaL, and a shell of a sensor of the mass flow meter is provided on a horizontal direction.

An access point A of the sampling by-pass pipe connecting with an access of the gas-liquid cylindrical cyclone is 1-1000 mm higher than an access point B of a converge of the liquid outlet pipeline and the vapor pipeline connecting on an access of the bypass pipeline.

These and other objectives, features, and advantages of the present invention will become apparent from the following detailed description, the accompanying drawings, and the appended claims.

### BRIEF DESCRIPTION OF THE DRAWINGS

Combining with the accompanying drawings and the preferred embodiments, further description of the present invention is illustrated as follows.

FIG. 1 is a sketch view according to a preferred embodiment of the present invention.

FIG. 2 is a sketch view according to another preferred embodiment of the present invention.

### DETAILED DESCRIPTION OF THE PREFERRED EMBODIMENT

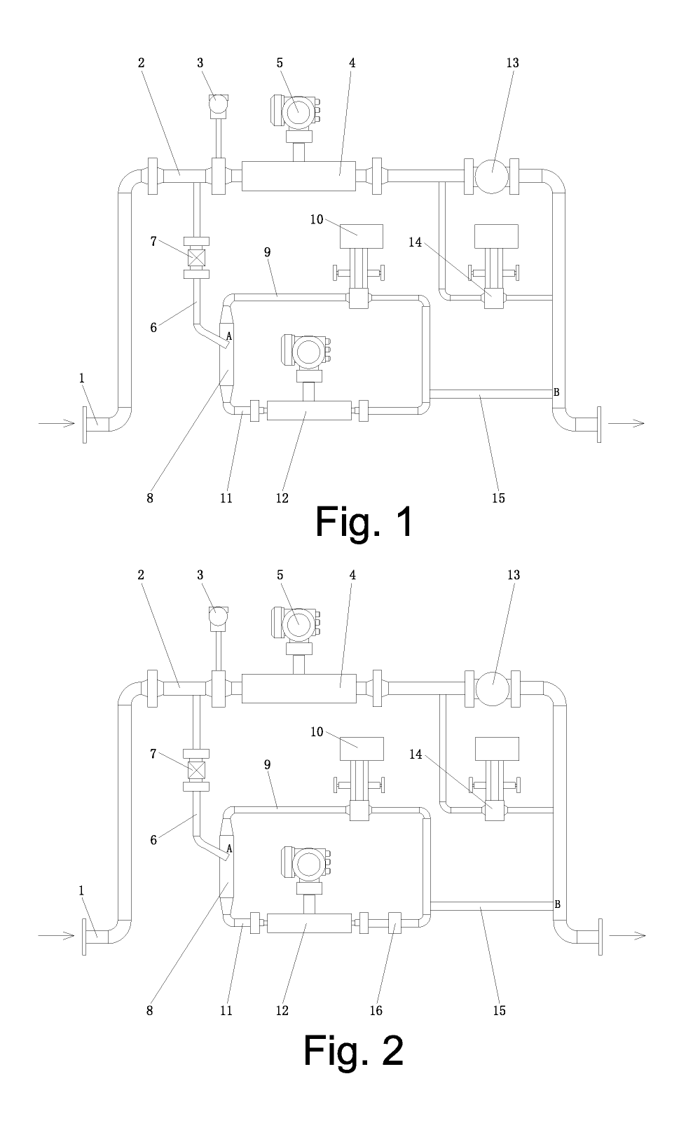

As shown in FIG. 1 and FIG. 2, the present invention provides an oil-gas-water three-phase flow meter comprising a main pipeline 1; wherein a commingler 2, a pressure sensor 3 and a gas-liquid two-phase flow meter 4 are respectively provided on a horizontal straight pipe section of the main pipeline 1, a flow computer 5 is provided on a gauge outfit of the gas-liquid two-phase flow meter 4, a sampling by-pass pipe 6 is connected on the horizontal straight pipe section of the main pipeline between the commingler 2 and the gas-liquid two-phase flow meter 4, a flow regulating valve 7 and a gas-liquid cylindrical cyclone 8 are provided on the sampling by-pass pipe 6, a vapor pipeline 9 on a top of the gas-liquid cylindrical cyclone 8 is connected with a gas flow meter 10, a bottom of the gas-liquid cylindrical cyclone 8 is connected with the liquid outlet pipeline 11, a mass flow meter 12 is provided on a horizontal straight pipe section of the liquid outlet pipeline 11; the flow computer 5 is respectively connected with the pressure sensor 3 and the mass flow meter 12 via a data line. Further more, as shown in FIG. 2, according to another preferred embodiment of the present invention, the mass flow meter 12 in FIG. 1 is replaced by an oil cut meter 12 and a liquid flow meter 16.

A differential pressure switch valve 13 is connected on an output terminal of the gas-liquid two-phase flow meter 4 on the main pipeline 1, a small diameter and low flow rate flow meter 14 is connected in parallel on two terminals of the differential pressure switch valve 13, wherein the small diameter and low flow rate flow meter 14 is connected with the flow computer 5 via a data line.

The small diameter and low flow rate flow meter 14 is preferred a throttle flow meter, a velocity flow meter or a ultrasonic flow meter.

A product of a volume and a pressure of the gas-liquid cylindrical cyclone 8 is less than 2.5 MpaL, and a shell of a sensor of the mass flow meter 12 is provided on a horizontal direction.

The liquid outlet pipeline 11 is merged with the vapor pipeline 9 and then connected with a bypass pipeline, the bypass pipeline 15 is connected with the main pipeline 1; an access point A of the sampling by-pass pipe 6 connecting with an access of the gas-liquid cylindrical cyclone 8 is 1-1000 mm higher than an access point B of a converge of the liquid outlet pipeline 11 and the vapor pipeline 9 connecting on an access of the bypass pipeline.

Working principle of the present invention is as follows. The main pipeline 1 measures a gas-liquid two-phase flow rate via a gas-liquid two-phase flow meter 4. A vapor density is manually inputted to the flow computer 5 from external, a liquid density is obtained from measurement of the mass flow meter 12 in a sampling bypass. Finally, a gas-liquid two-phase flow is calculated by the flow computer according to the pressure measured. A gas phase and a liquid phase are separated via the gas-liquid cylindrical cyclone 8 on the sampling bypass. The liquid phase is measured by a mass flow meter 12 and a water content in oil is measure by a density method, or the water content in oil is measured by the mass flow meter 12 and the liquid flow meter 16 as shown in FIG. 2, and meanwhile a liquid density is obtained; and finally an oil-gas-water three-phase flow is obtained by the flow computer.

In addition, when a gas-liquid flow rate in the main pipeline 1 is smaller than a lower limit of the gas-liquid two-phase flow meter 4, the differential pressure switch valve 13 is switched off, at this moment, the gas-liquid mixed density is measure by the gas-liquid two-phase flow meter 4, and the gas-liquid two-phase flow still can be calculated by the flow computer 5. When the gas-liquid flow rate in the main pipeline 1 is greater than the lower limit of the gas-liquid two-phase flow meter 4, the differential pressure switch valve 13 is switched on, at this moment, the gas-liquid mixed density and the gas-liquid two-phase flow are only measured by the gas-liquid two-phase flow meter 4 and the small diameter and low flow rate flow meter 14 does not anticipated in measuring; in such a manner that, the whole measuring device is capable of ensuring a high measurement accuracy and a small loss of pressure in a sufficiently wide measurement range.

Not belonging to a pressure vessel, the present invention has a small volume and a high performance cost ratio. Furthermore, the oil-gas-liquid three-phase flow meter has an in-operation vapor liquid volume ratio of 1000:1, and a range ratio up to 300:1, wherein the measurement range of the present invention is highly improved and thus the present invention is a satisfying multiphase product.

What is claimed is:

1. An oil-gas-water three-phase flow meter comprising: a main pipeline; wherein a commingler, a pressure sensor and a gas-liquid two-phase flow meter are respectively provided on a horizontal straight pipe section of the main pipeline, a flow computer is provided on a gauge outfit of the gas-liquid two-phase flow meter, a sampling by-pass pipe is connected on the horizontal straight pipe section of the main pipeline between the commingler and the gas-liquid two-phase flow meter, a flow regulating valve and a gas-liquid cylindrical cyclone are provided on the sampling by-pass pipe, a vapor pipeline on a top of the gas-liquid cylindrical cyclone is connected with a gas flow meter, a bottom of the gas-liquid cylindrical cyclone is connected with the liquid outlet pipeline, a mass flow meter; or an oil cut meter and a liquid flow meter are provided on a horizontal straight pipe section of the liquid outlet pipeline; the flow computer is respectively connected with the pressure sensor and the mass flow meter; or the oil cut meter and the liquid flow meter via a data line.

2. The oil-gas-water three-phase flow meter, as recited in claim 1, wherein a differential pressure switch valve is connected on an output terminal of the gas-liquid two-phase flow meter on the main pipeline, a small diameter and low flow rate flow meter is connected in parallel on two terminals of the differential pressure switch valve, wherein the small diameter and low flow rate flow meter is connected with the flow computer via a data line.

3. The oil-gas-water three-phase flow meter, as recited in claim 2, wherein the small diameter and low flow rate flow meter is a throttle flow meter, a velocity flow meter or a ultrasonic flow meter.

4. The oil-gas-water three-phase flow meter, as recited in claim 1, wherein a product of a volume and a pressure of the gas-liquid cylindrical cyclone is less than 2.5 MpaL, and a shell of a sensor of the mass flow meter is provided on a horizontal direction.

5. The oil-gas-water three-phase flow meter, as recited in claim 1, wherein an access point A of the sampling by-pass pipe connecting with an access of the gas-liquid cylindrical cyclone is 1-1000 mm higher than an access point B of a converge of the liquid outlet pipeline and the vapor pipeline connecting on an access of the bypass pipeline.
